(19) United States
(12) Patent Application Publication
(10) Pub. No.: US 2026/0032297 A1
(43) Pub. Date: Jan. 29, 2026

(54) SYSTEMS AND METHODS FOR LIVE VIDEO DATA STREAMING THROUGH UPSCALING, UPMAPPING, AND UPMIXING

(71) Applicant: Warner Bros. Discovery, Inc., New York, NY (US)

(72) Inventors: Neal ROBERTS, Lake Placid, FL (US); Kenneth WILSON, Las Vegas, NV (US); Peter VELLOS, Simi Valley, CA (US); Alexander BORBELY, Navarre, OH (US); Joshua BARNARD, Seattle, WA (US); Adrian MILLER, Redmond, WA (US)

(21) Appl. No.: 19/220,218

(22) Filed: May 28, 2025

Related U.S. Application Data
(60) Provisional application No. 63/674,574, filed on Jul. 23, 2024.

(51) Int. Cl. H04N 21/2343; H04N 21/2187; H04N 21/462

(52) U.S. Cl. CPC H04N 21/2343; H04N 21/2187; H04N 21/4621

(57) ABSTRACT

Systems and methods are disclosed for maintaining the accuracy and/or creative intent of broadcast content. One method comprises receiving broadcast content from one or more data stores, wherein the broadcast content includes video data and audio data, and wherein the video data includes a plurality of frames, analyzing at least one of the plurality of frames to determine at least one display attribute, based on the analyzing, creating, via a transcoder, metadata corresponding to the at least one display attribute, updating, by the one or more processors, the broadcast content by attaching the metadata to the at least one of the plurality of frames of the broadcast content, and transmitting the updated broadcast content to a device, wherein the device is configured to output the broadcast content based on the metadata.

### TECHNICAL FIELD

This patent application claims the benefit of priority to U.S. Provisional Application No. 63/674,574, filed Jul. 23, 2024, which is incorporated herein by reference in its entirety.

### TECHNICAL FIELD

The present disclosure relates to live video data and audio data broadcasting/steaming and, more particularly, to systems and methods for maintaining the accuracy and/or creative intent for live broadcast and VOD data streaming of audiovisual content through upscaling resolution data corresponding to the audiovisual content, upmapping display data corresponding to the audiovisual content, and upmixing audio data corresponding to the audiovisual content.

### BACKGROUND

Since the beginning of color broadcast television (TV), broadcasters have struggled to maintain the accuracy and/or creative intent (accurate colors, brightness, sounds, etc.) of the broadcast content delivered to a consumer's home and/or device. This may be due to uncontrollable steps and changes to the broadcast content signal after the broadcast content signal leaves the broadcast facility.

For example, if the broadcast content includes video data of a red Ferrari, such a color may not be displayed accurately on the user's device (i.e., in “Ferrari Red”) because the video data may have been modified, intentionally and/or inadvertently, after the video data left the broadcast facility. Additionally, by way of further example, skin tones may be shifted and displayed incorrectly on a user's device, as compared to actual skin tones originally captured by a recording/broadcasting device. Dark areas are often displayed too brightly and bright areas are often clipped because the bright areas are too bright.

These inaccuracies in broadcast content quality may occur during transmission and/or during converting and rendering at a consumer's device. Many of the issues described above may occur when the user's TV or other device makes assumptions about the content and chooses its own manufacturer-set methods to “stretch” (not map) the received content. For example, some TVs/devices may shift slightly red or blue, some may be overly dark, or some may be overly bright. As a result, consumers may experience a lack of consistency across devices according to device manufacturer settings.

Another issue may include users modifying the settings of their televisions or other display devices in an attempt to improve the picture and/or sound of the device. This may result in a lack of control for the broadcaster, especially when delivering standard-dynamic-range video (SDR video) to the user device.

As a result, a need exists for a process to deliver to a user device a video and audio experience that is optimized to best match the audiovisual fidelity of the broadcast event and/or the creator's intent (i.e., the color, resolution, sound received by the user best matches the “original” subject of the content). To that end, a need also exists for a system and process that allows the broadcaster to control and maintain content output configuration settings that correspond to those closest to the original broadcast content, but within the capabilities of the user device.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

Embodiments of the present disclosure include systems and methods for maintaining the creative intent for live broadcast data streaming.

According to certain embodiments, computer-implemented methods are disclosed for maintaining the accuracy and/or creative intent of broadcast content. One method may include receiving, by one or more processors, broadcast content from one or more data stores, wherein the broadcast content includes video data and audio data, and wherein the video data includes a plurality of frames. The method may include analyzing, by the one or more processors, at least one of the plurality of frames to determine at least one display attribute. The method may include, based on the analyzing, creating, by the one or more processors, via a transcoder, metadata corresponding to the at least one display attribute. The method may include updating, by the one or more processors, the broadcast content by attaching the metadata to the at least one of the plurality of frames of the broadcast content. The method may include transmitting, by the one or more processors, the updated broadcast content to a device, wherein the device is configured to output the broadcast content based on the metadata.

According to certain embodiments, a computer system for maintaining the accuracy and/or creative intent of broadcast content is disclosed. The computer system may comprise a memory having processor-readable instructions stored therein, and one or more processors configured to access the memory and execute the processor-readable instructions, which when executed by the one or more processors configures the one or more processors to perform a plurality of functions. The functions may include receiving, by the one or more processors, broadcast content from one or more data stores, wherein the broadcast content includes video data and audio data, and wherein the video data includes a plurality of frames. The functions may include analyzing, by the one or more processors, at least one of the plurality of frames to determine at least one display attribute. The functions may include, based on the analyzing, creating, by the one or more processors, via a transcoder, metadata corresponding to the at least one display attribute. The functions may include updating, by the one or more processors, the broadcast content by attaching the metadata to the at least one of the plurality of frames of the broadcast content. The functions may include transmitting, by the one or more processors, the updated broadcast content to a device, wherein the device is configured to output the broadcast content based on the metadata.

According to certain embodiments, a non-transitory computer-readable medium containing instructions for maintaining the accuracy and/or creative intent of broadcast content is disclosed. The instructions may include receiving, by one or more processors, broadcast content from one or more data stores, wherein the broadcast content includes video data and audio data, and wherein the video data includes a plurality of frames. The instructions may include analyzing, by the one or more processors, at least one of the plurality of frames to determine at least one display attribute. The instructions may include, based on the analyzing, creating, by the one or more processors, via a transcoder, metadata corresponding to the at least one display attribute. The instructions may include updating, by the one or more processors, the broadcast content by attaching the metadata to the at least one of the plurality of frames of the broadcast content. The instructions may include transmitting, by the one or more processors, the updated broadcast content to a device, wherein the device is configured to output the broadcast content based on the metadata.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a schematic diagram illustrating an example networked computing environment implementing methods and systems of this disclosure, according to one or more embodiments.

FIG. 2 depicts a conceptual flow diagram of an exemplary process for maintaining the accuracy and/or creative intent of broadcast content through upscaling resolution data, upmapping display data, and upmixing audio data corresponding to the broadcast content, according to one or more embodiments.

FIG. 3 depicts a schematic diagram of contents of an exemplary adaptive bit rate (“ABR”) ladder for upscaling, upmapping, and upmixing broadcast multimedia content, according to one or more embodiments.

FIG. 4 depicts an exemplary flow diagram of an exemplary method for maintaining the accuracy and/or creative intent of broadcast content, according to one or more embodiments.

FIG. 5 depicts an example system that may execute techniques presented herein, according to one or more embodiments.

### DETAILED DESCRIPTION OF EMBODIMENTS

Storytelling begins at the lens of the camera and may end at the display of a user device. Many complex systems exist between the lens and the display that may negatively manipulate and change content, resulting in departures from the accuracy and/or original creative intent (e.g., colors, brightness, sounds) of the data transmitted between the lens and the user display. The process of creating audio data and video data is time-consuming and complicated, and broadcasters spend significant time to create accurate and lifelike pictures and sound. However, the broadcaster's effort to convey ideal colors, brightness, sounds, etc. may be inhibited by distribution devices and user devices inadvertently and/or intentionally modifying the video data and/or audio data via compression, encoding, transcoding, packaging, decoding, and other processes.

Most of the deficiencies (i.e., loss of image, sound, and color fidelity) described above may occur when the user's TV, mobile device, and/or other display device makes assumptions about the broadcast content, and/or uses its own manufacturer-specific methods by which to “stretch” (not map) the received broadcast content. For example, some TVs, mobile devices, and/or other display devices may “stretch” the television content, which may result in shifting the content slightly red or blue, some may be overly dark, or some may be overly bright. As a result, consumers may experience content that is not true to the originally captured content, and/or consumers may experience a lack of consistency across devices made by different manufacturers.

Another issue may include users modifying the settings of their televisions and other devices in an attempt to improve the picture and/or sound of the device. This may result in a lack of control for the broadcaster, especially when delivering standard-dynamic-range video (SDR video) to the user device. As a result, a need exists for a process to deliver a video and audio experience to a user device that is optimized to best match the audiovisual fidelity of the broadcast event and/or the creator's intent (i.e., the color, resolution, sound received by the user best matches the “original” subject of the content). To that end, a need also exists for a system and process that allows the broadcaster to control and maintain content output configuration settings that correspond to those closest to the original broadcast content, but within the capabilities of the user device.

Accordingly, the present disclosure describes a system that may place broadcast data, which may include video data and/or audio data, into one or more “containers” that include one or more output configurations that specify how the data should be output to a device. The system may transmit the broadcast data in the container to a user device for display. For example, the container may correspond to a Standard Dynamic Range (SDR) display or a High Dynamic Range (HDR) display. By placing the audio and video content in the highest-quality available container (e.g., HDR), the broadcast content may have its resolution data upscaled (or “upressed”), its display data (e.g., color) upmapped (e.g., from SDR to HDR), and its audio data “upmixed,” there by keeping the content as close to its original state as possible, and obviating the need for user- and/or device-initiated manipulation.

More specifically, as described herein, “upmapping” video content may refer to the process of converting the display format of the video content from SDR to HDR, such as through color space upmapping from SDR to HDR, including Dolby Vision® metadata generation using lookup tables and CPU/GPU processing. “Upscaling” or “upressing” the resolution data may refer to the process of converting the resolution of the video data from one resolution level to a higher resolution level. Additionally, “upmixing” audio data may refer to the process of generating audio content with additional speaker output channels/signals, e.g., by adding one or more additional speaker output channels to broadcast content originally transmitted with fewer speaker output channels. Using these techniques, live production elements like skin tones, dark/bright highlights, arena/venue sounds, object colors, and the overall look and feel and sound of events, for example, may now be broadcast and delivered to consumer devices with a higher level of accuracy and quality.

According to certain aspects of the disclosure, systems and methods are disclosed that deliver and/or convert broadcast data received from one or more remote systems or venues into 1080p resolution data, standard dynamic range (SDR) display data, as well as 5.1 or stereo audio data, by using one or more content containers that specify the given resolution, audio specification, or the like. Utilizing the content containers may allow for the creator to impact how content may be output via the user device, as well as remove any assumptions that the user device may typically make with, for example, SDR and 5.1 stereo (e.g., incorrectly stretching the audio and video content). Additionally, utilizing the content containers that specify output configurations may also give the creator confidence that the user is seeing and hearing the video data and audio data that is accurate and delivered in the manner the creator intended. The systems and methods may include using creator-approved live workflows by utilizing look up tables, as well as other processes, to map content into the appropriate content container. Additionally, metadata may be applied to the content containers to specify the desired resolution or quality specifications, thereby obviating the need for the consumer and/or device to further manipulate the received content.

Thus, the disclosed systems and methods provide a novel, end-to-end video delivery workflow that transforms standard dynamic range (SDR) and 5.1 audio source content into a premium HDR and Dolby Atmos® experience, without requiring changes to upstream production infrastructure. Unlike traditional workflows that rely on native HDR capture or allow downstream devices to perform unpredictable format conversions, the disclosed system and method implements a controlled, cloud-based transformation pipeline that ensures creative intent is preserved across all playback environments. The system uses a custom transcoder to upres 1080i to 1080p, upmap SDR to HDR via finely tuned look-up tables on a GPU/CPU, and upmix 5.1 sound to Dolby Atmos® (5.1.4). The system also employs dual adaptive bit rate (ABR) ladder generation, enabling the simultaneous creation of HDR and SDR adaptive bitrate ladders from a single SDR source, enabling seamless playback on both advanced and legacy devices. The system also uses custom container management to enable precise handling of Dolby Vision® metadata, synchronized audio, and video in multiple output formats (HLS, MPEG-DASH), with error-resistant protocols (e.g., Secure Reliable Transport (SRT)). By inserting HDR and audio metadata within well-defined containers, the system prevents consumer devices from making incorrect display assumptions, thus avoiding color distortion or audio downmixing errors.

Advantages of the systems and methods may include ensuring that the created content will be viewed on user devices in the manner closest to the captured live event and/or desired by the content creator. For example, by placing the audio data and the video data in a container (e.g., a standard dynamic range (SDR) container), and using metadata, the content creator may be confident that the broadcast content may be experienced in the manner desired by the content creator. Additionally, existing and/or legacy broadcast technologies may not allow for the preservation of creative intent because of the device's ability to shift display attributes, such as brightness and color, based on device manufacturer defaults. Additional advantages may include reducing the processing complexities of the user device that are currently needed to output the content.

In sum, the disclosed overall pipeline or workflow enables broadcast-quality HDR/Dolby Atmos® output from SDR input, at scale, without upgrading production trucks, control rooms, or cameras. No other known system supports this type of creative-intent-preserving transformation with full adaptive streaming support across modern and legacy endpoints. Unlike traditional workflows that rely on native HDR capture or allow downstream devices to perform unpredictable format conversions, this system implements a controlled, cloud-based transformation pipeline that ensures creative intent is preserved across all playback environments.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, relative terms, such as, for example, “about,” “substantially,” “generally,” and “approximately” are used to indicate a possible variation of ±10% in a stated value. The term “exemplary” is used in the sense of “example” rather than “ideal.” As used herein, the singular forms “a,” “an,” and “the” include plural reference unless the context dictates otherwise.

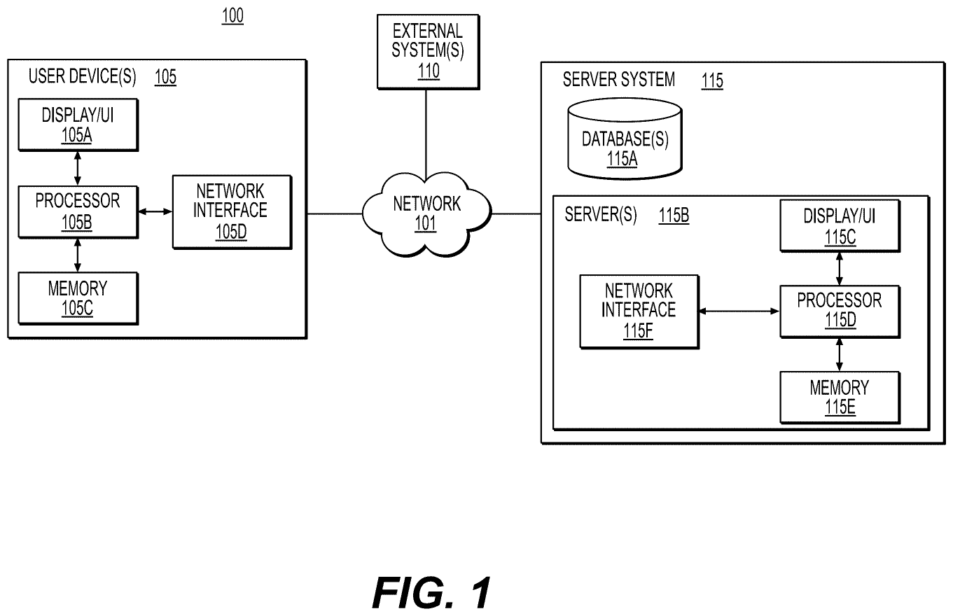

FIG. 1 depicts an exemplary environment 100 that may be utilized with the techniques presented herein. Environment 100 may include one or more user device(s) 105, one or more external system(s) 110, and one or more server system(s) 115 which may communicate across an electronic network 101. As will be discussed in further detail below, one or more server system(s) 115 may communicate with one or more of the other components of the environment 100 across network 101. The one or more user device(s) 105 (e.g., a television, a mobile device, or any other multimedia content display device) may be associated with a user (e.g., a consumer and/or a viewer).

In some embodiments, the components of the environment 100 are associated with a common entity. In some embodiments, one or more of the components of the environment are associated with entities different from one another. The systems and devices of the environment 100 may communicate in any arrangement.

The user device 105 may be configured to enable the user to access and/or interact with other systems in the environment 100. For example, the user device 105 may be a television or a computer system such as, for example, a desktop computer, a mobile device, a tablet, etc. In some embodiments, the user device 105 may include one or more electronic application(s), e.g., a program, plugin, browser extension, etc., installed on a memory of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser. In some embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115. For example, external systems 110 may include partner data stores, cloud storage systems, multimedia content catalogs, and/or multimedia content distribution systems or pipelines. External systems 110 may be in communication with other device(s) or system(s) in the environment 100 over the one or more networks 101. For example, external systems 110 may communicate with the server system 115 via API (application programming interface) access over the one or more networks 101, and also communicate with the user device(s) 105 via web browser access over the one or more networks 101.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In some embodiments, the server system 115 includes and/or interacts with an application programming interface for exchanging data to other systems, e.g., one or more of the other components of the environment.

The server system 115 may include a database 115A and at least one server 115B. The server system 115 may be a computer, system of computers (e.g., rack server(s)), and/or or a cloud service computer system. The server system may store or have access to database 115A (e.g., hosted on a third party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

Although depicted as separate components in FIG. 1, it should be understood that any component or portion of any component in the environment 100 may, in some embodiments, be integrated with or incorporated into one or more other components. For example, a portion of the display 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

In these methods, various acts may be described as performed or executed by a component from FIG. 1, such as the server system 115, the user device 105, or components thereof. However, it should be understood that in various embodiments, various components of the environment 100 discussed above may execute instructions or perform acts including the acts discussed above and below. An act performed by a device may be considered to be performed by a processor, actuator, or the like associated with that device. Further, it should be understood that in various embodiments, various steps may be added, omitted, and/or rearranged in any suitable manner.

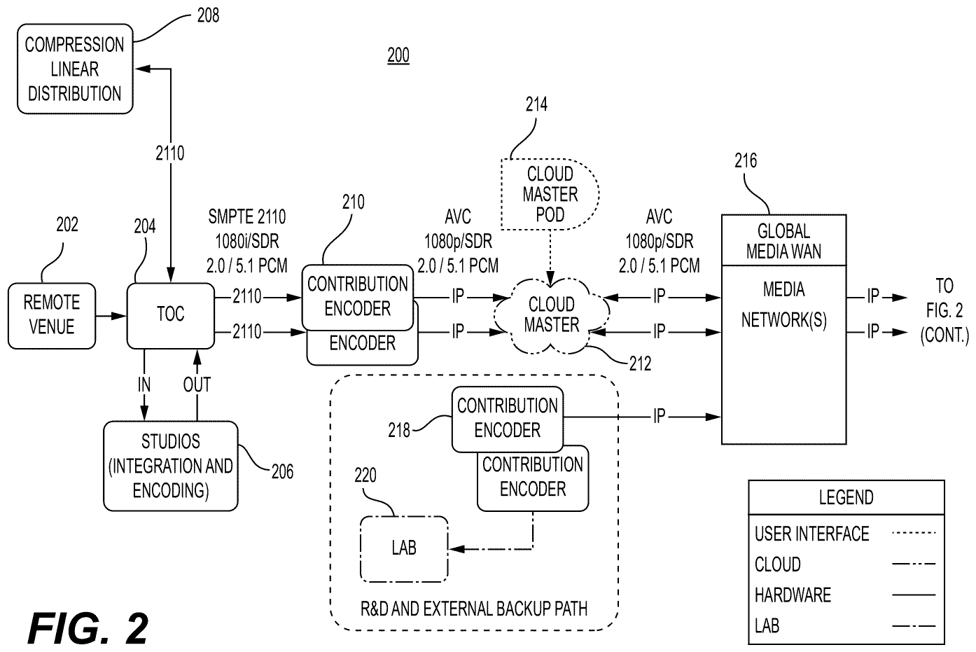

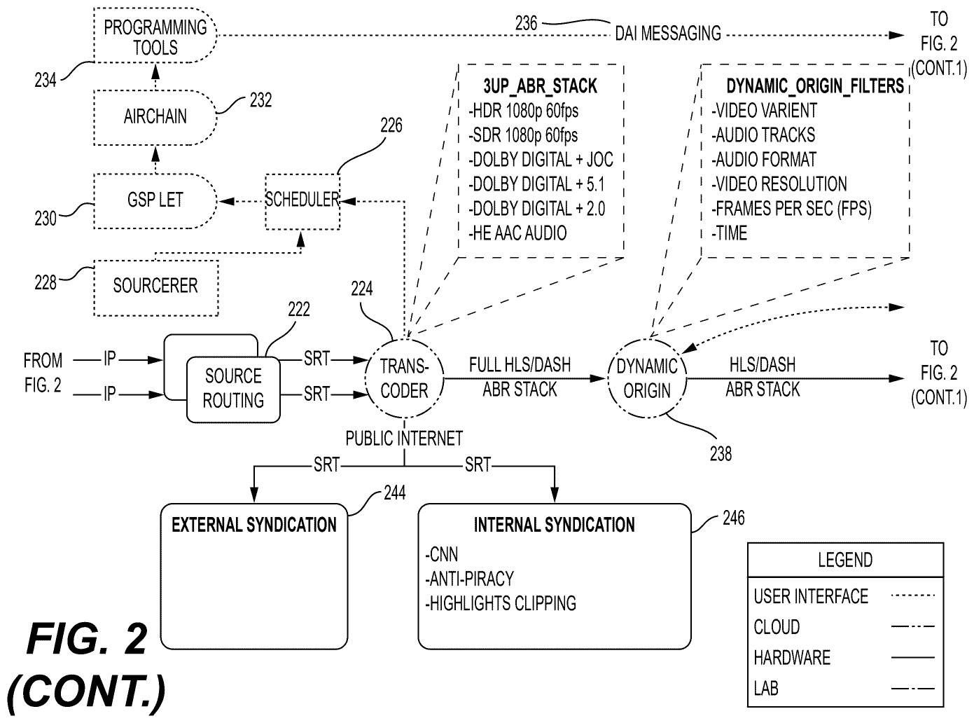

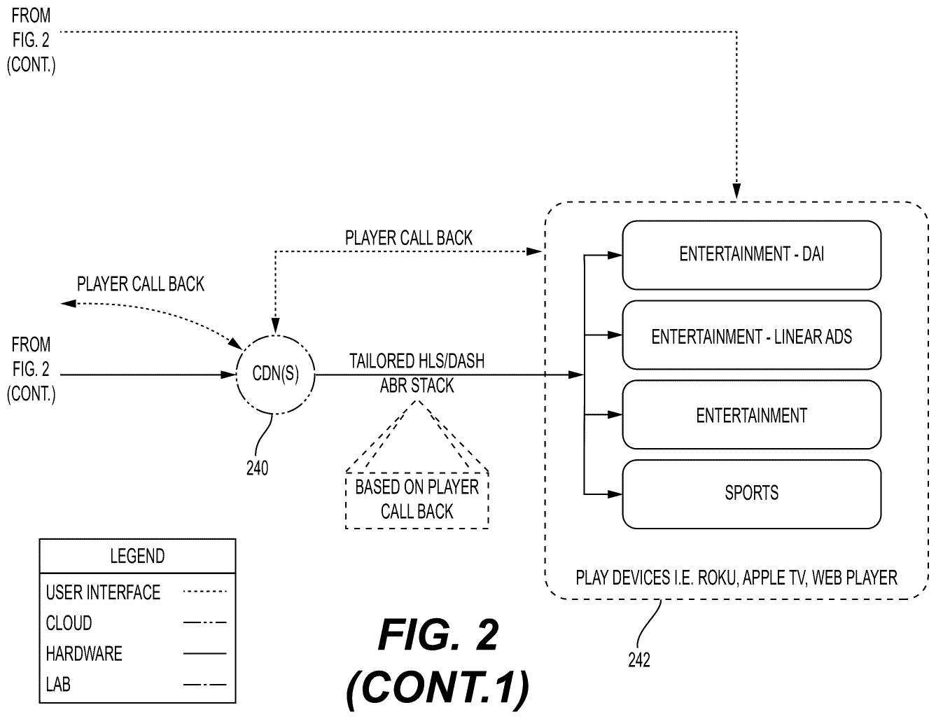

In general, any process or operation discussed in this disclosure that is understood to be computer-implementable, such as the processes illustrated in FIGS. 2-4, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

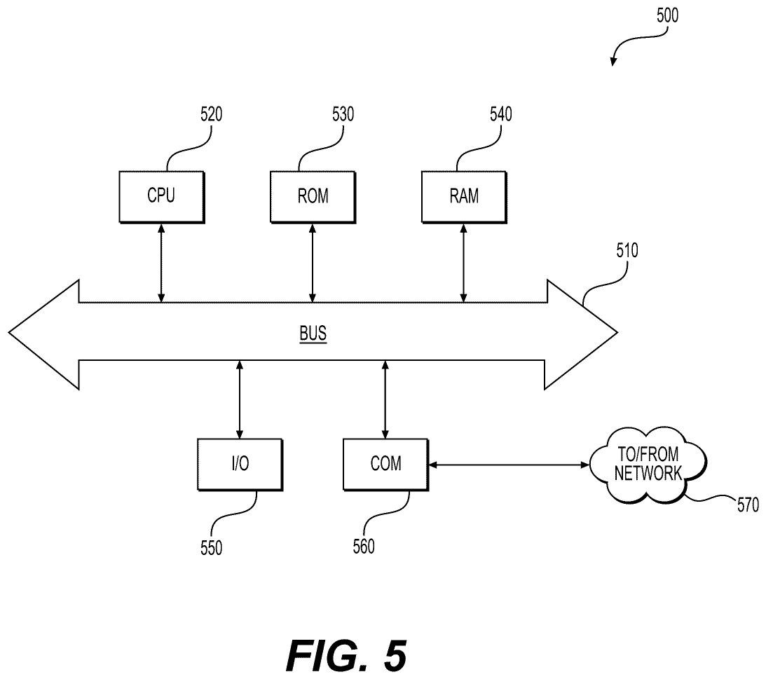

FIG. 2 depicts an exemplary system architecture and method 200 for maintaining the accuracy and/or creative intent of broadcast data, according to one or more embodiments. Notably, system architecture and method 200 may be implemented by one or more processors of a server (e.g., server system 115) that is in communication with one or more user devices (e.g., user device(s) 105) and other external system(s) (e.g., external system(s) 110) via a network (e.g., network 101). However, it should be noted that method 200 may be performed by any one or more of the server, one or more user devices, or other external systems. Exemplary system architecture and method 200 may be executed on one or more components of FIG. 1 or 5.

A remote venue 202 may include cameras and/or sensors that capture and/or create broadcast data (e.g., audio data and/or video data). For example, the remote venue may correspond to a sports arena, where the cameras may capture a sports game. In some embodiments, the cameras may capture the sports game in SDR. Alternatively, remote venue 202 may be any physical location and/or filming location where multimedia content is captured by a lens or other sensor.

The remote venue 202 may send the broadcast data to a technical operations center (TOC) 204. The TOC 204 may then transmit and/or receive the broadcast data to and/or from one or more studios 206, which polish the broadcast data via integration and encoding processes. Additionally, or alternatively, the TOC 204 may transmit and/or receive the broadcast data for compression linear distribution 208, for some or all of the broadcast data to be compressed. In some embodiments, the broadcast data may be transmitted to compression linear distribution module 208 using Society of Motion Picture and Television Engineers (SMPTE) 2110 transport protocols.

As shown in FIG. 2, technical operations center 204 may then transmit the broadcast data (optionally compressed by compression linear distribution module 208) to a contribution encoder 210. Contribution encoder 210 may upscale the resolution of the broadcast data, for example, from 1080i to 1080p. For example, technical operations center 204 may send the broadcast data (e.g., in 1080i, SDR, 2.0/5.1 PCM format) to one or more contribution encoders 210, where the broadcast data may include one or more of the following attributes: SDR, 1080i, Dolby® Multichannel PCM 2.0, and/or Pulse Code Modulation 5.1. The one or more contribution encoders 210 may then convert (e.g., upscale) the 1080i resolution data corresponding to the broadcast data into 1080p (e.g., 1080p 60 fps) resolution data that corresponds to the broadcast data, resulting in updating the resolution of the broadcast video. For example, the 1080i broadcast data may be deinterlaced (e.g., upscaled) to 1080p broadcast data.

The one or more contribution encoders 210 may then send the broadcast data, which includes the 1080p resolution data, to the cloud master 212. In some embodiments, the broadcast data (e.g., in 1080p, SDR, 2.0/5.1 PCM format) may be transmitted to cloud master 212 using Advanced Video Coding (AVC) standards. Cloud master 212 may be configured to interact with the cloud master pod 214, in order to update/augment the broadcast data to include advertisement data corresponding to one or more advertisements. In some embodiments, the advertisement data may be upmixed to 5.1 surround sound, and then further upmixed to 5.1.4 (Dolby Atmos®), by cloud master 212.

The cloud master 212 may then send the broadcast data to a global media Wide-Area Network (WAN) 216. In some embodiments, the broadcast data (e.g., in 1080p, SDR, 2.0/5.1 PCM format) may be transmitted to the global media WAN 216 using AVC standards. The global media WAN 216 may allow the system to push and pull broadcast data all over the world via a private network. Global media WAN 216 may serve as a multicast-to-unicast adapter, leveraging Secure Reliable Transport (SRT) protocol for secure and reliable ingest into cloud-based systems. For example, the global media WAN 216 may pull and receive additional broadcast data/resources from Europe for use in the United States. The global media WAN 216 may interact with other media systems (e.g., those that store data outside of the United States) to update the broadcast video.

The global media WAN 216 may further receive additional event data (e.g., the raw video feed) from a lab 220 via another contribution encoder 218. In some embodiments, the additional event data may act as a point of reference to validate master control data included in the broadcast data. For example, if the broadcast data includes video data that is fuzzy, the system may access the corresponding raw video data to see if the original raw video data is also fuzzy.

The global media WAN 216 may send the broadcast data to source routing 222. In some embodiments, the broadcast data (e.g., in 1080p, SDR, 2.0/5.1 PCM format) may be transmitted to the source routing 222 using AVC standards. The source routing 222 may be responsible for managing, joining, and/or distributing the Media WAN Multicast Network, and then converting data from the Media WAN Multicast Network and converting the broadcast data into SRT video for the transcoder (e.g., it converts Multicast IPs into SRT). For example, the broadcast data may be converted for external syndication (e.g., external syndication 244) and/or internal syndication (e.g., internal syndication 246).

The source routing 222 may then send the broadcast data to the transcoder 224. In some embodiments, the transcoder may also receive broadcast content from data stores, in real-time, and the like. The broadcast content may include video data and/or audio data. Additionally, the video data may include a plurality of video frames.

In general, the transcoder 224 may create various forms of metadata that may be attached to the broadcast data. For example, the transcoder may receive the content in SDR, and then place the broadcast data into a HDR container (e.g., thereby “upmapping” the color space of the broadcast data). Alternatively, the transcoder may receive the broadcast data in HDR, and then put the broadcast data into an SDR container (e.g., thereby “downmapping” the color space of the broadcast data).

It should be appreciated that the transcoder module 224 may be embedded within or operate as part of the contribution encoder 210. Together, contribution encoder 210 and transcoder 224 (among other modules) may be considered an ABR “stack”, which supports adaptive bitrate delivery through transcoding, ABR ladder generation, containerization, and containerization, among other things.

More specifically, in one embodiment, the transcoder module 224 receives a combined video and audio input stream, typically composed of interlaced 1080i video formatted in Standard Dynamic Range (SDR) and accompanying 5.1 channel linear PCM audio. The transcoder 224 initially performs a deinterlacing step to convert the 1080i signal into a progressive 1080p60 signal to support higher frame-rate adaptive streaming formats. Following deinterlacing, the transcoder 224 (again, possibly combined with contribution encoder 210) executes a color space transformation using GPU-accelerated lookup tables (LUTs) and/or CPU-based logic to convert the SDR video into an HDR format. In certain embodiments, the HDR format may comply with Dolby Vision® specifications, and the transcoder may generate associated dynamic metadata on a per-frame basis.

The transcoder 224 also executes an audio upmixing process, wherein the 5.1 channel audio is algorithmically processed into both 5.1 Dolby Digital Plus™ and object-based Dolby Atmos® audio using software-defined audio processors. Simultaneously, a stereo AAC track is generated as a baseline fallback for compatibility with low-end or bandwidth-constrained devices.

Upon completing the core enhancements, the transcoder 224 initiates adaptive bitrate (ABR) ladder generation. In one embodiment, the transcoder 224 produces at least two ABR ladders: a first ladder for HDR video streams and a second ladder for SDR video streams. Each ladder includes a plurality of renditions, varying by resolution (e.g., 240p, 360p, 540p, 720p, 1080p), frame rate (e.g., 30 fps, 60 fps), and bitrate (e.g., 300 Kbps to 10 Mbps). The audio tracks generated in earlier steps are multiplexed and synchronized with each corresponding video rendition.

Each audio-video rendition is then packaged into streaming containers suitable for delivery over adaptive streaming protocols. In some embodiments, the transcoder 224 packages the renditions into fragmented MP4 (fMP4) containers for use in MPEG-DASH workflows and MPEG-TS containers for compatibility with legacy HLS-based systems. Time synchronization across segments is preserved through precise alignment mechanisms to facilitate seamless adaptive playback.

During packaging, the transcoder 224 injects necessary metadata including Dolby Vision® dynamic metadata for HDR renditions, custom tone-mapping profiles for SDR variants, playback identifiers, syndication tags, and dynamic origin routing data. The metadata ensures accurate downstream playback across heterogeneous device types while enabling real-time control over delivery policies, including device filtering, fallback prioritization, and region-specific manifest customization.

The transcoder 224 concludes its processing by transmitting the packaged ABR ladders, associated manifest files (e.g., .m3u8 for HLS, .mpd for MPEG-DASH), and all supporting metadata to an origin server or content delivery network (CDN) (e.g., dynamic origin 238). These outputs are structured for immediate adaptive delivery, supporting end-user playback scenarios that dynamically select the best possible rendition based on device capabilities, network conditions, and policy controls.

Through this integrated process, the transcoder 224 enables the transformation of conventional SDR broadcast inputs into a scalable, premium-grade, HDR/Dolby Atmos® streaming experience while maintaining fidelity to the original creative intent and ensuring wide compatibility across both legacy and next-generation consumer playback environments.

Thus, in one embodiment, the transcoder 224 may analyze at least one of the frames to determine a display attribute. Additionally, or alternatively, the transcoder may analyze the at least one frames to determine an audio attribute. For example, the audio attribute may include an audio standard (e.g., Dolby® Digital 5.1, Advanced Audio Coding (AAC)), and the like. In some embodiments, the analyzing may also include analyzing the video data and/or the audio data to determine the subject of the content. For example, if the video content corresponds to a sporting event, the broadcast content may already be in a HDR format. As a result, the process may proceed to transmitting the broadcast content to the user device, without upmapping the broadcast content to HDR.

The transcoder may, based on the analyzing, create metadata corresponding to the at least one attribute. For example, the transcoder may create an adaptive bit rate (ABR) ladder (e.g., metadata). The ABR ladder may correspond to different video and audio formats that the transcoder may be configured to transcode. For example, the ABR ladder may include one or more output configurations, where the one or more output configurations may include at least one of: a 1080i format, a 1080p format, a standard dynamic range (SDR) format, a HDR format, 5.1 surround sound, High Efficiency Video Coding (HEVC), a bandwidth amount (e.g., 3800 kbps), and/or Dolby Atmos® surround sound. In one embodiment, the transcoder 224 may encapsulate processed content into adaptive bitrate (ABR) ladders-distinct for HDR and SDR-offering various resolutions, bitrates, and audio formats. These ladders are then packaged into media containers such as MPEG-DASH or HLS (using fMP4 or TS), supporting compatibility with a wide range of devices, from basic SDR televisions to Dolby Vision®-capable smart TVs.

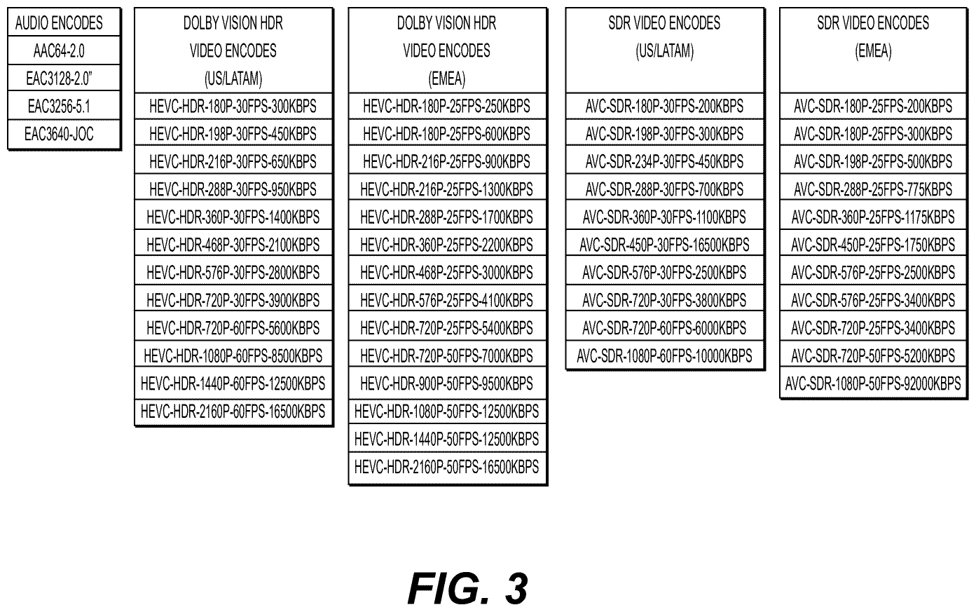

FIG. 3 illustrates exemplary output configurations of an ABR ladder, according to one or more embodiments. For example, the ABR ladder may include one or more containers, such as an HDR container (e.g., Dolby Vision® HDR Video Encodes), an SDR container (e.g., SDR Video Encodes), and/or an audio container (e.g., Audio Encodes). Each container may include one or more output configurations. The output configurations may depend on the location of the streaming device (e.g., US/Latin America (LATAM) or Europe, the Middle East, and Africa (EMEA)). The output configurations for the HDR container may include HEVC, HDR, a HDR resolution amount (e.g., 1080p), a frames per second (fps) amount (20 fps), and/or a bandwidth amount (e.g., 300 kbps). The output configurations for the SDR container may include AVC, SDR, a HDR resolution amount (e.g., 1080p), a frames per second (fps) amount (20 fps), and/or a bandwidth amount (e.g., 300 kbps). The output configurations for the audio container may include Advanced Audio Coding (AAC), Dolby® Digital Plus (E-AC-3), and/or surround sound specifications (5.1 surround sound). In some embodiments, the output configurations may be stored in increasing value. Alternatively, the output configurations may be stored in decreasing value. For example, a user device may iterate through the output configurations that are stored in increasing value until the output configurations correspond to the maximum abilities of the user device.

In some embodiments, creating the metadata may include the transcoder downmapping HDR content to SDR content. The transcoder may update the broadcast content by attaching the metadata (e.g., ABR ladder) to the frame of the broadcast content. The transcoder may then transmit the updated broadcast content to a device (e.g., user device 105). For example, the ABR stack may deliver the metadata in multiple levels in the form of various ABR ladders (e.g., SDR and HDR ladders). Additionally, the ABR ladders may include the output configurations sorted from low quality and increase the options based on the network quality and the device capabilities. The device may be configured to output the broadcast content based on the ABR ladder configurations. For example, the device may read the video data and the output configurations to determine that the output configurations include an HDR display format and a 1080p resolution, and then output the video data of the broadcast content in a HDR and 1080p format. Additionally, the device may read the audio data and the output configurations to output the audio data to one or more audio devices (e.g., speakers) based on the output configurations of the ABR ladders.

The transcoder process may include upmixing audio data from a smaller container to a higher container (e.g., Dolby Atmos®), up mapping video data from a standard dynamic range to a high dynamic range (e.g., Dolby Vision®), and/or upscaling the resolution from 30 fps to 60 fps. The transcoder may take in a signal (e.g., broadcast content) and transcode the signal to any video and/or audio specifications. The transcoder may distribute the signal via HLS, Dash, SRT, and/or RTMP protocols to either the origin, a third party origin, and/or directly to the partner via SRT or RTMP.

In some embodiments, the transcoder may transmit the ABR ladders and the broadcast content to the dynamic origin 238 using streaming protocols such as Dynamic Adaptive Streaming over HTTP (DASH) and/or HTTP Live Streaming (HLS). The dynamic origin 238 may correspond to n built in logic that may allow for user devices to call the dynamic origin 238, which may then determine what type of video and audio the user device may be capable of playing. Based on the call back, the dynamic origin 238 may call the ABR stack to deliver the ABR ladder appropriate for the specific user device (e.g., by filtering the ABR ladders based on the user device capabilities). This may reduce the amount of data that is sent from the content delivery network (CDN) 240, resulting in eliminating the waste of unused bandwidth and increasing optimal user device performance. The dynamic origin filter may include the potential video and audio variants that the origin may filter to create the tailored ABR ladder that may be sent to the player devices 242.

The dynamic origin 238 may transmit the filtered ABR ladders and the broadcast content to the CDN 240 via one or more streaming protocols (e.g., HLS, DASH) (e.g., server system 115). The CDN 240 may receive a call back from the player device 242, and the CDN 240 may communicate the call back to the dynamic origin 238. Additionally, the CDN 240 may receive the filtered ABS ladder(s) from the dynamic origin 238 and then send the ABR ladder to the user device 105.

The CDN 240 may thus transmit the filtered ABR ladder(s) and the broadcast content to the user device 105, where the user device 105 may output the broadcast content based on the output configurations specified in the ABR ladder(s).

Additionally, or alternatively, in some embodiments, the transcoder 224 may send the broadcast content and the full set of ABR ladders to the scheduler 226. The scheduler 226 may include a scheduler system that may allow operators to create, schedule, configure, and/or manage the transcoder 224. Scheduler 226 may be directly linked to the sourcerer database 228 to allow operators to select the right source within the multicast network (e.g., global media WAN 216).

The sourcerer 228 may include a database and a GUI interface that may allow operators the ability to manage, store, and/or update the multicast sources. The sourcerer 228 may include a database (e.g., database records) that keeps track of IP addresses and may translate the IP addresses to friendly names. For example, the sourcerer 228 may receive a multicast address and convert the multicast address into a friendly name for operators.

The GSP LET 230 may send the broadcast content and the ABR ladders to the airchain module 232. For example, the GSP LET 230 may include a user interface where events may be pre-scheduled. The airchain 232 may then send the broadcast content and the ABR ladders to programming tools 234. For example, the airchain module 232 may include image/cover art creation and/or storage, for sending to programming tools 234.

The programming tools 234 may then send the broadcast content and the ABR ladders to the user device 105 via, for example, DAI messaging 236. Upon receiving the broadcast content and the ABR ladders, the user device 105 may play/display the broadcast content according to the output configurations of the ABR ladders on one or more user interfaces of the user device. The broadcast content may include entertainment and/or sports content that includes different types of advertisements (e.g., linear advertisements).

For example, referring to FIG. 3, the user device 105 may select either the HDR container or the SDR container, based on whether the user device supports HDR or SDR. The user device 105 may then start playing the broadcast content according to the first row of output configurations in either the HDR or the SDR containers. The user device 105 may then iterate through the output configurations until the output configurations correspond to the maximum abilities of the user device. For example, if the user device has SDR capabilities, the user device may select the “SDR Video Encodes” container. The user device may begin with displaying the video data of the broadcast content according to the “AVC-SDR-180p-30 fps-200 kbps” output configurations. The user device may then iterate through the output configurations until the output configurations are the maximum of the user device's capabilities. For example, the user device may stop at the “AVC-SDR-720p-30 fps-3800 kbps” because the bandwidth may be unable to support bandwidth higher than 3800 kbps. The user device may go through the same process for the audio data of the broadcast content.

Although FIG. 2 shows example blocks of exemplary method 200, in some implementations, the exemplary method 200 may include additional blocks, fewer blocks, different blocks, or differently arranged blocks than those depicted in FIG. 2 Additionally, or alternatively, two or more of the blocks of the exemplary method 200 may be performed in parallel.

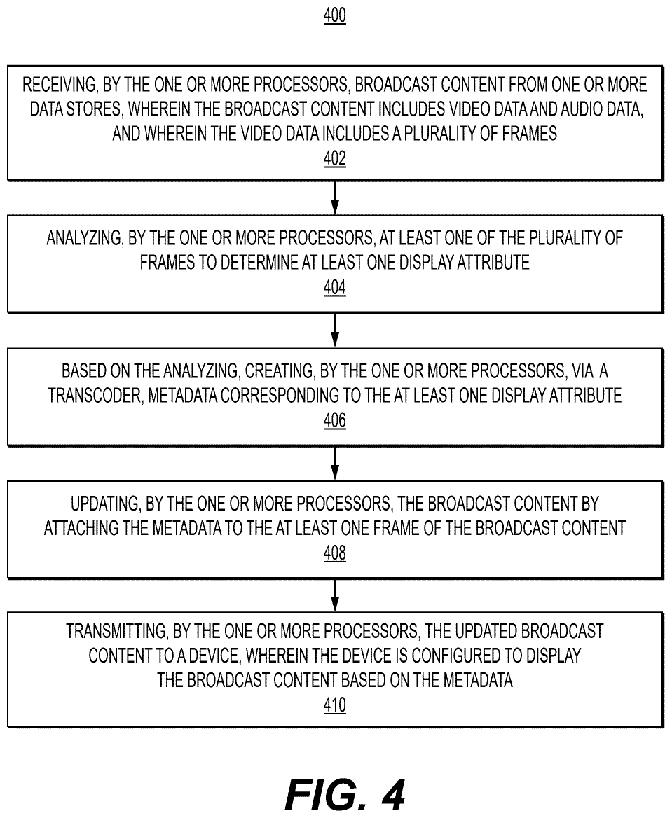

FIG. 4 depicts a schematic diagram of an exemplary method 400 for maintaining creative intent of broadcast content, according to one or more embodiments. Notably, method 400 may be performed by one or more processors of a server (e.g., server system 115) that is in communication with one or more user devices (e.g., user device(s) 105) and other external system(s) (e.g., external system(s) 110) via a network (e.g., network 101). In particular, method 400 may be performed by one or more processors of contribution encoder 210, cloud master 212, global media WAN 216, source routing 222, and/or transcoder 224, the operations of any of which may be combined together or separated in any combination of servers or processors of server system 115. However, it should be noted that method 400 may be performed by any one or more of the server, one or more user devices, or other external systems. Exemplary method 400 may be executed on one or more components of FIG. 1 or 5.

In one embodiment, method 400 may include receiving, by one or more processors, broadcast content from one or more data stores (e.g., database 115A), wherein the broadcast content includes video data and audio data, and wherein the video data includes a plurality of frames (Step 402). In some embodiments, the broadcast content may be in a high dynamic range (HDR) format. In some embodiments, the transcoder may be the component that receives the broadcast content. Additionally, the broadcast content may be received in real-time. The broadcast content may include video data and/or audio data. Additionally, the video data may include a plurality of video frames.

For example, in some embodiments, prior to receiving the broadcast content, the method may include capturing, by the one or more processors, via one or more cameras, the broadcast content at one or more venues. As described above, one or more cameras and/or sensors at a remote venue may capture and/or create the broadcast content. For example, the remote venue may correspond to a sports arena, where the cameras may capture a sports game. In some embodiments, the cameras may capture the sports game in SDR. The method may also include storing, by the one or more processors, the broadcast content in the one or more data stores.

In some embodiments, the method may include deinterlacing, by the one or more processors, at least one of the plurality of frames into a 1080p format, wherein the at least one of the plurality of frames previously had a 1080i format. For example, deinterlacing (e.g., upscaling) the frame into a 1080p format may improve the quality of the video data.

The method may include analyzing, by the one or more processors, at least one of the plurality of frames to determine at least one display attribute (Step 404). For example, the display attribute may include a resolution (e.g., 1080p), a display standard (e.g., SDR, HDR), bandwidth and the like. Additionally, or alternatively, the transcoder may analyze the at least one frames to determine an audio attribute. For example, the audio attribute may include an audio standard (e.g., Dolby® Digital 5.1, Advanced Audio Coding (AAC)), and the like. In some embodiments, the analyzing may also include analyzing the video data and/or the audio data to determine the subject of the content. For example, if the video content corresponds to a sporting event, the process may proceed to transmitting the broadcast content to the user device, without creating metadata for the frames in the broadcast content.

The method may include, based on the analyzing, creating, by the one or more processors, via a transcoder (e.g., server system 115), metadata corresponding to the at least one display attribute (Step 406). In some embodiments, the metadata may include an adaptive bit rate (ABR) ladder, which is illustrated in FIG. 3. The ABR ladder may include one or more output configurations, and wherein the one or more output configurations includes at least one of: a 1080i format, a 1080p format, a standard dynamic range (SDR) format, a HDR format, 5.1 surround sound, and/or Dolby Atmos® surround sound.

In some embodiments, creating the metadata corresponding to the at least one display attribute may further include: converting, by the one or more processors, via the transcoder, one or more colors of the at least one of the plurality of frames, wherein the converting (e.g., upmapping) includes utilizing a lookup table. For example, if the broadcast content was originally captured (e.g., filmed by one or more cameras) in an SDR format, but one of the output configurations of the transmitted ABR ladder is HDR, then the transcoder may convert the colors of the SDR frame into one or more colors of a HDR frame (e.g., by mapping according to a lookup table). The transcoder may select a color in the frame and then analyze the color to determine a color identifier. The transcoder may access a lookup table, input the color identifier into the lookup table, and the transcoder may then receive an updated color identifier that may be mapped (e.g., upmapped) to the input color identifier. For example, the lookup table may store one or more color associations, where the color associations may be between SDR colors and HDR colors.

The method may then include updating, by the one or more processors, the broadcast content by attaching the metadata to the at least one of the plurality of frames of the broadcast content (Step 408). For example, the updating may include storing the broadcast content and the metadata in one or more data stores. The updating may include correlating the frame to the related metadata. As a result of the updating, the system may be able to identify the metadata (e.g., the output configurations of the ABR ladder) that relate to a particular frame.

In some embodiments, the method may further include receiving, by the one or more processors, a call back from the device (e.g., user device 105), wherein the call back includes at least one device attribute. For example, a user may interact with a user interface (e.g., display/UI 105A) of the user device, such as by making a selection of content that is displayed on the user interface. The user interaction may trigger the user device to send a call back to the system (e.g., server system 115). The call back may include at least one device attribute that corresponds to the user device. The device attribute may indicate one or more technical capabilities of the user device. For example, the device attribute may include at least one of: a resolution (e.g., 1080p), a display standard (e.g., SDR, HDR), bandwidth, audio capabilities, and the like. The method may further include filtering, by the one or more processors, the available ABR ladders based on the at least one device attribute. For example, the system may remove a set of output configurations (e.g., one ABR ladder from the available ABR ladders), where the removed output configurations do not specifically apply to the user device. The method may further include updating, by the one or more processors, the updated broadcast content based on the filtered ABR ladder. For example, the updated broadcast content may be further updated to include the output configurations that correspond to the device attributes. Additionally, the further updated broadcast content may then be transmitted to the device.

The method may include transmitting, by the one or more processors, the updated broadcast content to a device, wherein the device is configured to output the broadcast content based on the metadata (Step 410). As described above, the transcoder may then transmit the updated broadcast content to a device (e.g., user device 105). For example, the ABR stack may deliver the metadata in multiple levels. Additionally, the ABR stack may generate the ABR ladders including the desired output configurations sorted from low quality and increase the options based on the network quality and the device capabilities. The device may be configured to output the broadcast content based on the generated ABR ladders. For example, the device may read the video data and the output configurations to display the video data of the broadcast content based on the output configurations of the ABR ladders. Additionally, the device may read the audio data and the output configurations to output the audio data to one or more audio devices (e.g., speakers) based on the output configurations of the ABR ladders.

Although FIG. 4 shows example blocks of exemplary method 400, in some implementations, the exemplary method 400 may include additional blocks, fewer blocks, different blocks, or differently arranged blocks than those depicted in FIG. 4 Additionally, or alternatively, two or more of the blocks of the exemplary method 400 may be performed in parallel.

FIG. 5 illustrates a high-level functional block diagram of an exemplary computer system 500, in which embodiments of the present disclosure, or portions thereof, may be implemented, e.g., as computer-readable code. For example, each of the exemplary devices and systems described above with respect to FIG. 5 can be implemented in computer system 500 using hardware, software, firmware, tangible computer readable media having instructions stored thereon, or a combination thereof and may be implemented in one or more computer systems or other processing systems. Hardware, software, or any combination of such may embody any of the modules and components in FIG. 5, as described above.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the present disclosure, as described above in the examples of FIGS. 2-4 may be implemented using computer system 500, shown in FIG. 5. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments, the order of operations may be rearranged without departing from the spirit of the disclosed subject matter.

FIG. 5 provides a functional block diagram illustration of general purpose computer hardware platforms. FIG. 5 illustrates a network or host computer platform 500, as may typically be used to implement a server, such as user device(s) 105, external system(s) 110, and server system 115. It is believed that those skilled in the art are familiar with the structure, programming, and general operation of such computer equipment and, as a result, the drawings should be self-explanatory.

A platform for a server or the like 500, for example, may include a data communication interface for packet data communication 560. The platform may also include a central processing unit (CPU) 520, in the form of one or more processors, for executing program instructions. The platform typically includes an internal communication bus 510, program storage, and data storage for various data files to be processed and/or communicated by the platform such as ROM 530 and RAM 540, although the computer platform 500 often receives programming and data via network communications 570. The hardware elements, operating systems, and programming languages of such equipment are conventional in nature, and it is presumed that those skilled in the art are adequately familiar therewith. The computer platform 500 also may include input and output ports 550 to connect with input and output devices such as keyboards, mice, touchscreens, monitors, displays, etc. Of course, the various computer platform functions may be implemented in a distributed fashion on a number of similar platforms, to distribute the processing load. Alternatively, the computer platforms may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as those used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It would also be apparent to one of skill in the relevant art that the present disclosure, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

It is to be understood that both the foregoing general description and the following detailed description are exemplary and explanatory only and are not restrictive of the disclosed embodiments, as claimed.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1. A computer-implemented method for maintaining creative intent of broadcast content, the computer-implemented method comprising:
receiving, by one or more processors, broadcast content from one or more data stores, wherein the broadcast content includes video data and audio data, and wherein the video data includes a plurality of frames;
analyzing, by the one or more processors, at least one of the plurality of frames to determine at least one display attribute;
based on the analyzing, creating, by the one or more processors, via a transcoder, metadata corresponding to the at least one display attribute;
updating, by the one or more processors, the broadcast content by attaching the metadata to the at least one of the plurality of frames of the broadcast content; and
transmitting, by the one or more processors, the updated broadcast content to a device, wherein the device is configured to output the broadcast content based on the metadata.

2. The computer-implemented method of claim 1, wherein the metadata includes one or more adaptive bit rate (ABR) ladders defined by an output configuration of an ABR stack.

3. The computer-implemented method of claim 2, the computer-implemented method further comprising:
receiving, by the one or more processors, a call back from the device, wherein the call back includes at least one device attribute;
filtering, by the one or more processors, and selecting from among the ABR ladders based on the at least one device attribute; and
updating, by the one or more processors, the updated broadcast content based on the filtered and selected ABR ladder.

4. The computer-implemented method of claim 2, wherein the ABR ladders are defined by one or more output configurations, and wherein the one or more output configurations includes at least one of: a 1080i format, a 1080p format, a standard dynamic range (SDR) format, a HDR format, 5.1 surround sound, and/or Dolby Atmos® surround sound.

5. The computer-implemented method of claim 1, wherein the creating, via the transcoder, the metadata corresponding to the at least one display attribute includes:
converting, by the one or more processors, via the transcoder, one or more colors of the at least one of the plurality of frames, wherein the converting includes utilizing a lookup table.

6. The computer-implemented method of claim 1, the computer-implemented method further comprising:
deinterlacing, by the one or more processors, at least one of the plurality of frames into a 1080p format, wherein the at least one of the plurality of frames previously had a 1080i format.

7. The computer-implemented method of claim 1, the computer-implemented method further comprising:
capturing, by the one or more processors, via one or more cameras, the broadcast content at one or more venues; and
storing, by the one or more processors, the broadcast content in the one or more data stores.

8. The computer-implemented method of claim 1, wherein the broadcast content is in a high dynamic range (HDR) format.

9. A computer system for maintaining creative intent of broadcast content, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
receiving, by the one or more processors, broadcast content from one or more data stores, wherein the broadcast content includes video data and audio data, and wherein the video data includes a plurality of frames;
analyzing, by the one or more processors, at least one of the plurality of frames to determine at least one display attribute;
based on the analyzing, creating, by the one or more processors, via a transcoder, metadata corresponding to the at least one display attribute;
updating, by the one or more processors, the broadcast content by attaching the metadata to the at least one of the plurality of frames of the broadcast content; and
transmitting, by the one or more processors, the updated broadcast content to a device, wherein the device is configured to output the broadcast content based on the metadata.

10. The computer system of claim 9, wherein the metadata includes one or more adaptive bit rate (ABR) ladders defined by an output configuration of an ABR stack.

11. The computer system of claim 10, the functions further comprising:
receiving, by the one or more processors, a call back from the device, wherein the call back includes at least one device attribute;
filtering, by the one or more processors, and selecting from among the ABR ladders based on the at least one device attribute; and
updating, by the one or more processors, the updated broadcast content based on the filtered and selected ABR ladder.

12. The computer system of claim 10, wherein the ABR ladders are defined by one or more output configurations, and wherein the one or more output configurations includes at least one of: a 1080i format, a 1080p format, a standard dynamic range (SDR) format, a HDR format, 5.1 surround sound, and/or Dolby Atmos® surround sound.

13. The computer system of claim 9, wherein the creating, via the transcoder, the metadata corresponding to the at least one display attribute includes:
converting, by the one or more processors, via the transcoder, one or more colors of the at least one of the plurality of frames, wherein the converting includes utilizing a lookup table.

14. The computer system of claim 9, the functions further comprising:
deinterlacing, by the one or more processors, at least one of the plurality of frames into a 1080p format, wherein the at least one of the plurality of frames previously had a 1080i format.

15. The computer system of claim 9, the functions further comprising:
capturing, by the one or more processors, via one or more cameras, the broadcast content at one or more venues; and
storing, by the one or more processors, the broadcast content in the one or more data stores.

16. The computer system of claim 9, wherein the broadcast content is in a high dynamic range (HDR) format.

17. A non-transitory computer-readable medium containing instructions for maintaining creative intent of broadcast content, the instructions comprising:
receiving, by one or more processors, broadcast content from one or more data stores, wherein the broadcast content includes video data and audio data, and wherein the video data includes a plurality of frames;
analyzing, by the one or more processors, at least one of the plurality of frames to determine at least one display attribute;
based on the analyzing, creating, by the one or more processors, via a transcoder, metadata corresponding to the at least one display attribute;
updating, by the one or more processors, the broadcast content by attaching the metadata to the at least one of the plurality of frames of the broadcast content; and
transmitting, by the one or more processors, the updated broadcast content to a device, wherein the device is configured to output the broadcast content based on the metadata.

18. The non-transitory computer-readable medium of claim 17, wherein the metadata includes one or more adaptive bit rate (ABR) ladders defined by an output configuration of an ABR stack.

19. The non-transitory computer-readable medium of claim 18, the instructions further comprising:
receiving, by the one or more processors, a call back from the device, wherein the call back includes at least one device attribute;
filtering, by the one or more processors, and selecting from among the ABR ladders based on the at least one device attribute; and
updating, by the one or more processors, the updated broadcast content based on the filtered and selected ABR ladder.

20. The non-transitory computer-readable medium of claim 18, wherein the ABR ladders are defined by one or more output configurations, and wherein the one or more output configurations includes at least one of: a 1080i format, a 1080p format, a standard dynamic range (SDR) format, a HDR format, 5.1 surround sound, and/or Dolby Atmos® surround sound.
